(19) United States
(12) Patent Application Publication
(10) Pub. No.: US 2011/0023666 A1
(43) Pub. Date: Feb. 3, 2011

(54) FAST SCREWDRIVER BLADE CONNECTING STRUCTURE

(75) Inventor: Chung-Liang HSU, Taiping City (TW)

Correspondence Address: SENNIGER POWERS LLP, 100 NORTH BROADWAY, 17TH FLOOR, ST LOUIS, MO, 63102, US

(73) Assignee: CHUNG JAAN INDUSTRIAL CO., LTD., TAICHUNG COUNTY (TW)

(21) Appl. No.: 12/841,923

(22) Filed: Jul. 22, 2010

(30) Foreign Application Priority Data
Jul. 31, 2009 (TW) 98214137

(51) Int. Cl. B25B 23/00; B23B 31/107

(52) U.S. Cl. 81/438; 279/30

(57) ABSTRACT

A fast screwdriver connecting apparatus includes an elongated rod body, a first resilient unit, a second resilient unit, a movable inner tube and a hollow tube an inner portion of the elongated rod body has a plugging trough. A ring is extended from the plugging trough to form an arc ring slot, and a wedging groove with an opening to engage a wedging ring. A connecting element receives a steel ball, and the second resilient unit and the hollow tube are coupled to the connecting element. A circular slot of the hollow tube is aligned with the retracting hole, and a wedging slot is formed where the movable inner tube is aligned with inner wall of the elongated rod. Different sizes of screwdriver blades can be replaced from the elongated rod body to push against the resilient units, and the steel ball rolls into the wedging slot.

### CROSS-REFERENCE TO RELATED APPLICATION

This application claims the benefit of Taiwanese patent application Ser. No. [98214137] filed Jul. 31, 2009, and the entire disclosure of which is hereby incorporated by reference.

### FIELD OF THE INVENTION

This invention generally relates to improvement of screwdriver blade connecting structure. More specifically, this invention relates to the structure for fast engaging and disengaging the screwdriver blade to a screwdriver.

### BACKGROUND OF THE INVENTION

Conventionally, a connecting element 20 coupled to the screwdriver 10 (as shown in FIGS. 25 and 26) has a retractable hole 211 at outer portion of the rod body 21, and a steel ball 22 is placed at the retractable hole 211. Outer portion of the rod body 21 has a fixed stopping unit 212, a spring 23 at the outer circumference and a hollow tube 24 with a depressed inclined surface 241 stopped by the stopping unit 212. When the screwdriver 10 with a slot ring 101 is inserted into the connecting element 20, the hollow tube 24 is pressed to push the spring 23 inside and the steel ball 22 can be forced into the depressed inclined surface 241 of the hollow tube 24, such that the screwdriver 10 can be inserted momentarily. The steel ball 22 may restore to the retractable hole 211 to form a wedging condition against the slot ring 101 when the spring 23 is automatically back to its original position. However, a user has to press the hollow tube 24 frequently to push the spring 23 uni-directionally to engage the screwdriver 10, which may cause a problem that the user has to frequently press the hollow tube 24 to replace the screwdriver 10. This replacing process is slow and inconvenient, and may further reduce the needs from the market.

Moreover, there are at least four kinds of screwdrivers 10 with different sizes and conventionally, the design of the screwdriver 10 can only apply to one or two close sizes because of a large gap between a plugging end 11 of one side of the screwdriver 10 and the slot ring 101. Namely, the conventional design lacks of diverse applicability and practicability.

Under such circumstances, the inventor, who has experience in designing associated products for many years and realizes the limitations of the conventional design, presents this invention to provide an improvement of fast screwdriver blade connecting structure.

### SUMMARY OF THE INVENTION

It is an object of the present invention to provide improvement of fast screwdriver blade connecting structure, wherein a plugging trough inside the elongated rod body with appropriate depth to provide space for a resilient unit and a movable inner tube, and the elongated rod body has a retractable hole to accommodate the steel ball which is protruding from the plugging trough. Also, a ring with identical diameter engages with the edge of the plugging trough to form an arc ring trough, such that the movement of the movable inner tube exactly attaches to the ring without falling out because of the steel ball. When a screwdriver with similar shape of the plugging trough is inserted, the steel ball may go to the ring trough to provide more space for the insertion of the screwdriver.

It is another object of the present invention to provide an improvement of fast screwdriver blade connecting structure, wherein a wedging groove with an opening to engage a wedging ring is formed outside the elongated rod body. The wedging ring has a flat surface which is retractable in the opening and the plugging trough. When using a smaller screwdriver, the flat surface of the wedging ring can be pushed by the hollow tube to be against the positioning ring slot of the screwdriver to achieve the effect of securing the screwdriver, and therefore increase convenience and practicability of the present invention.

### BRIEF DESCRIPTION OF THE DRAWINGS

FIG. 1 illustrates a three-dimensional exploded view of the present invention.

FIG. 2 illustrates a first sectional view of an assembled apparatus of the present invention.

FIG. 3 illustrates a sectional view of a plugging trough in the present invention.

FIG. 4 depicts a second sectional view of an assembled apparatus of the present invention.

FIG. 5 depicts a third sectional view of an assembled apparatus of the present invention.

FIG. 6 depicts a first embodiment of the present invention.

FIG. 7 depicts a second embodiment of the present invention.

FIG. 8 depicts a third embodiment of the present invention.

FIG. 9 illustrates a three-dimensional exploded view of another embodiment of the present invention.

FIG. 10 is a sectional view of an assembled apparatus of the embodiment in FIG. 9.

FIG. 11 is an embodiment of FIG. 9.

FIG. 12 illustrates a three-dimensional exploded view of a further embodiment of the present invention.

FIG. 13 is a sectional view of an assembled apparatus of the embodiment in FIG. 12.

FIG. 14 is another embodiment of FIG. 12.

FIG. 15 illustrates a three-dimensional exploded view of a different embodiment of the present invention.

FIG. 16 is a sectional view of an assembled apparatus of the embodiment in FIG. 15.

FIG. 17 is a first embodiment of FIG. 15.

FIG. 18 is another embodiment illustrating a use of FIG. 15 and a screw.

FIG. 19 is a second embodiment of FIG. 15.

FIG. 20 is a three-dimensional exploded view of a torque device in the present invention.

FIG. 21 depicts a sectional view of an assembled torque device in FIG. 20.

FIG. 22 is an assembled sectional view of the torque device in FIG. 20 and a driving tool.

FIG. 23 illustrates a three-dimensional exploded view of a shaft and an elongated rod body in the present invention.

FIG. 24 illustrates a sectional view of a use case of FIG. 20.

FIG. 25 illustrates a sectional view of a prior art.

FIG. 26 illustrates a sectional view of a embodiment of the prior art.

### DETAIL DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications which might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

According to the drawings, embodiments of the present invention are detailed as following:

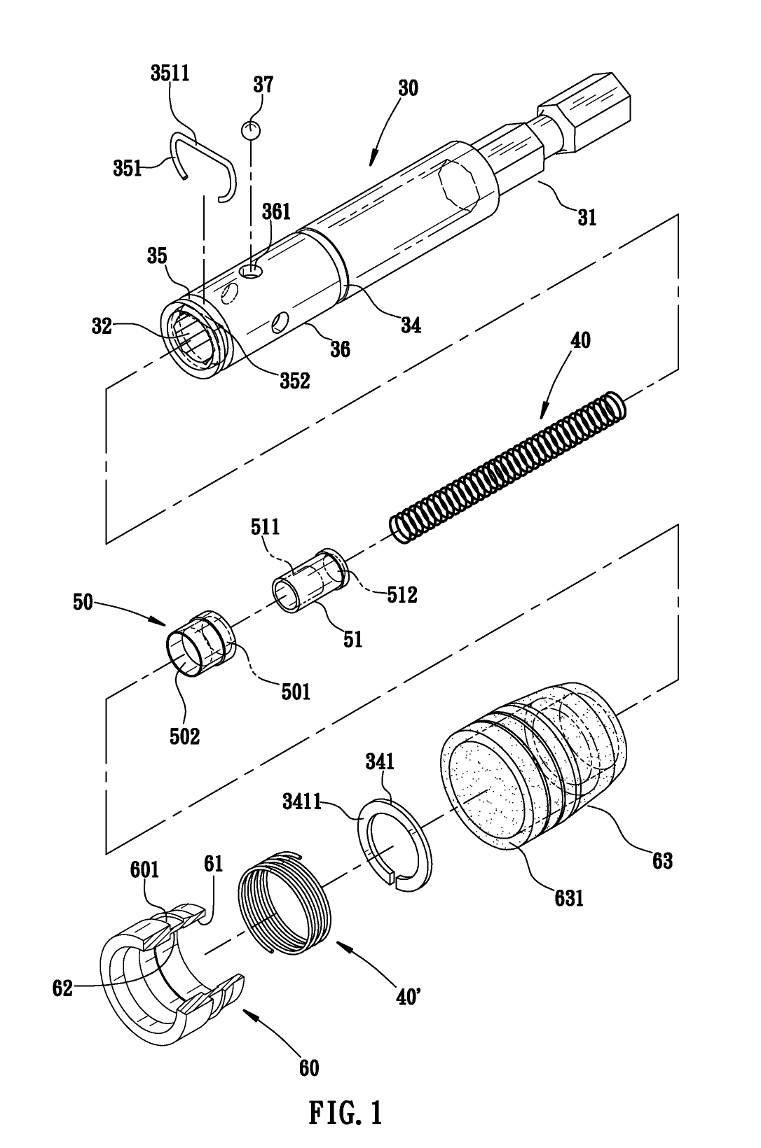

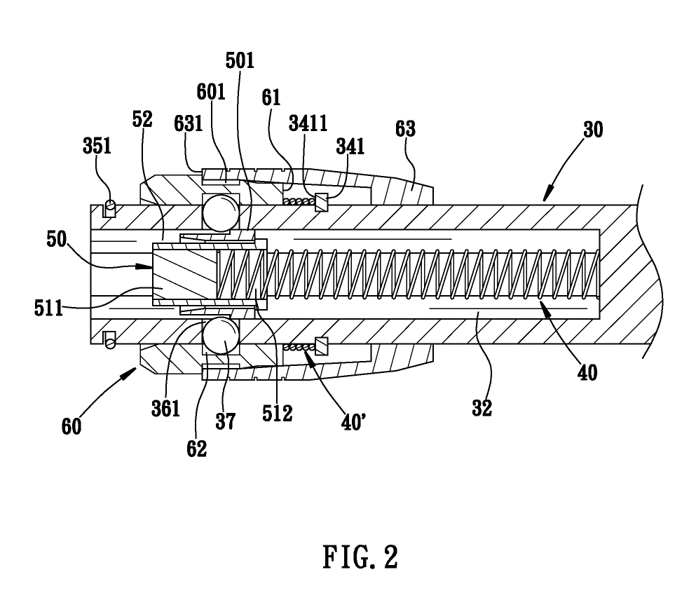

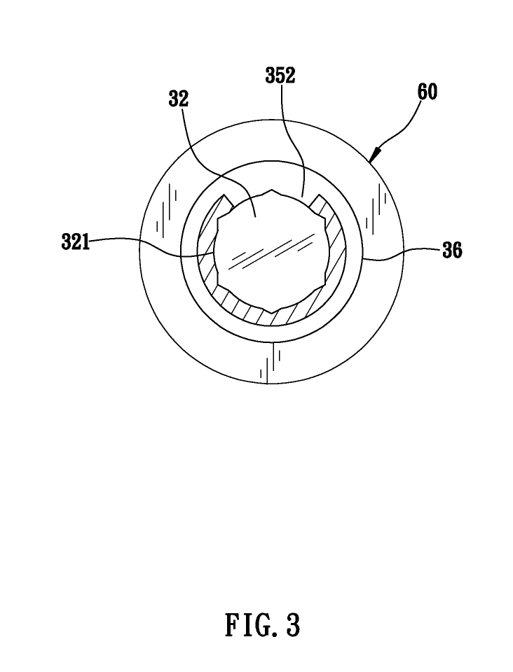

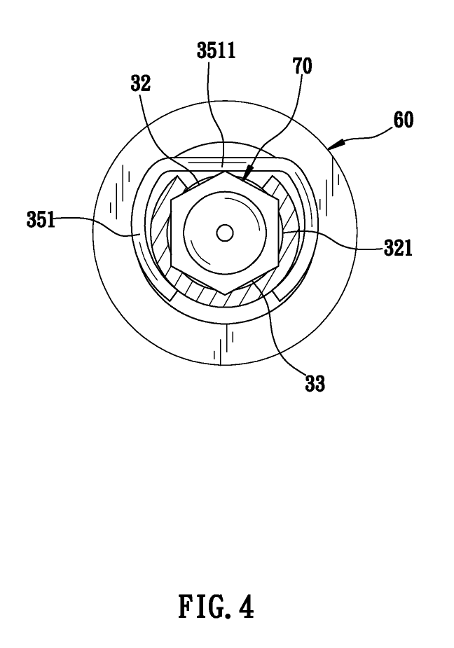

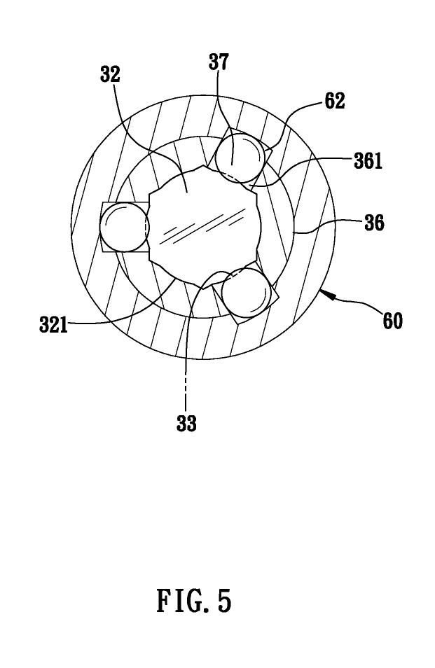

FIG. 1 illustrates a three-dimensional exploded view of the present invention (also referring to FIG. 2) including an elongated rod body 30, a first resilient unit 40, a second resilient unit 40′, a movable inner tube 50 and a hollow tube 60, wherein the elongated rod body 30 has a connecting end 31 and the other end with a hexagonal plugging trough 32 having a ring 321 with identical diameter encircling the circumference of the plugging trough 32 to form an arc circular slot 33 (as shown in FIGS. 3 and 4). A circular slot 34 and a wedging slot 35 are spaced in a predetermined distance on an outer portion of the elongated rod body 30 to form a larger diameter C-shaped protruding ring 341 to form a first shoulder portion 3411 engaged with a wedging ring 351, wherein one side of the wedging slot 35 has a planar through hole 352 to communicate with the plugging trough 32, such that the wedging ring 351 can be engaged with the wedging slot 35, and a planar portion 3511 of the wedging ring 351 is retractable within the plugging trough 32. A connecting element 36 is located between the circular slot 34 and the wedging slot 35, and a retractable hole 361 is formed at an appropriate location of the connecting element 36 to communicate with the plugging trough 32 to provide a space for a steel ball 37 (as shown in FIG. 5). An outer portion of the connecting unit 36 is enclosed by the second resilient unit 40′ and the hollow tube 60, wherein the second resilient unit 40′ is located between the circular slot 34 and the retractable hole 361, and one end is against the first shoulder portion 3411 and the other end is against a second shoulder portion 61 of the hollow tube 60. The inner wall of the hollow tube 60 has a ring-shaped slot 62 couple with the retractable hole 361 to provide a fixed position for the steel ball 37, such that the elongated rod body 30 can be pushed and slid by the resilient force provided by the second resilient unit 40′ and the hollow tube 60. The first resilient unit 40 and the movable inner tube 50 are placed in order in the plugging trough 32 of the elongated rod body 30, wherein the movable inner tube 50 is hollow and one end thereof is against the ring 321 with a circumference 501, and the other end has an inclined surface 502 inside where there is a linking unit 51 with a magnetic unit 511 on one end and a receiving space 512 on the other end. One end of the first resilient unit 40 is connected within the receiving space 512 and the linking unit 51 is protrudingly extended at one end of the movable inner tube 50 to form a wedging gap 52 which is a apace between the elongated rod body 30 and the inner tube 50. A portion of the steel ball 37 is against the circumference 501 of the movable inner tube 50 so that the movable inner tube 50 can be located within the plugging trough 32 to avoid falling out. A groove 601 is formed at the outer surface of the hollow tube 60 and the groove 601 can attach to one surface 631 of a plastic heat-contractible unit 63, such that the hollow tube 60, the second resilient unit 40′ and the protruding ring 341 are all protected inside the heat-contractible unit 63 and are linked to the hollow tube 60.

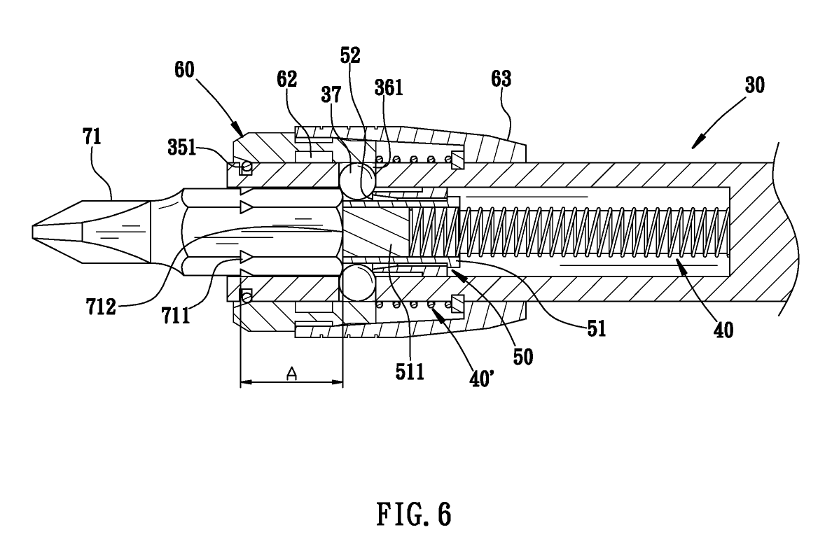

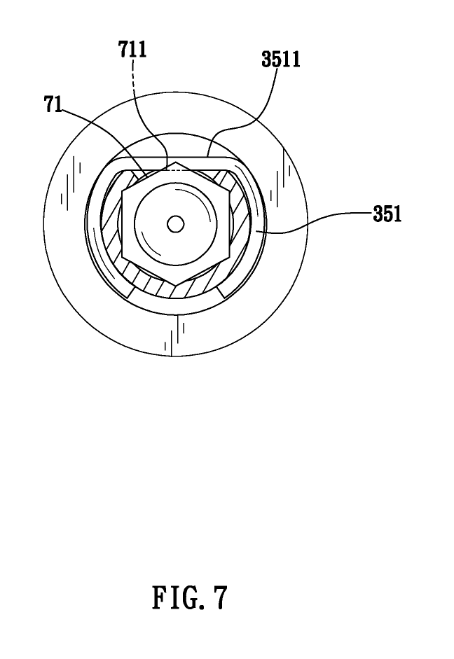

As shown in FIG. 6, the plugging trough 32 can accommodate different sizes of screwdrivers 70, and a lateral side of unidirectional screwdriver 71 has a positioning slot 711 spaced with one end of a plugging unit 72 by distance A (minimum distance), so when the unidirectional screwdriver 71 is pushed into the plugging trough 32, the steel ball 37 is first retracted into the arc circular slot 33 of the ring 321 to form a space to enable the unidirectional screwdriver 71, which closely attaches to the inner portion of the plugging trough 32, to be pushed into. The steel ball 37 located between the retractable hole 361 and the hollow tube 60 is moved into the wedging gap 52 of the movable inner tube 50 by the unidirectional screwdriver 71 which pushes the first resilient unit 40. Furthermore, the ring-shaped slot 62 of the hollow tube 60 is separated with the steel ball 37 and is pushed to the wedging ring 351 (shown in FIG. 7) by resilient force exerted by the second resilient unit 40′, such that the planar portion 3511 of the wedging ring 351 is forced to be against the positioning slot 711 of the unidirectional screwdriver 71 to achieve the effect of securing the unidirectional screwdriver 71. Or, the plastic unit 63 pushes the hollow tube 60 and the second resilient unit 40′ to cause the steel ball 37 rolling into the ring-shaped slot 62, such that the unidirectional screwdriver 71 is easier to be taken out for replacement by the resilient force exerted by the first resilient unit 40 on the movable inner tube 50. Meanwhile, the plugging unit 712 is magnetically attracted with the magnetic unit 511 of the linking unit 51 to avoid falling out.

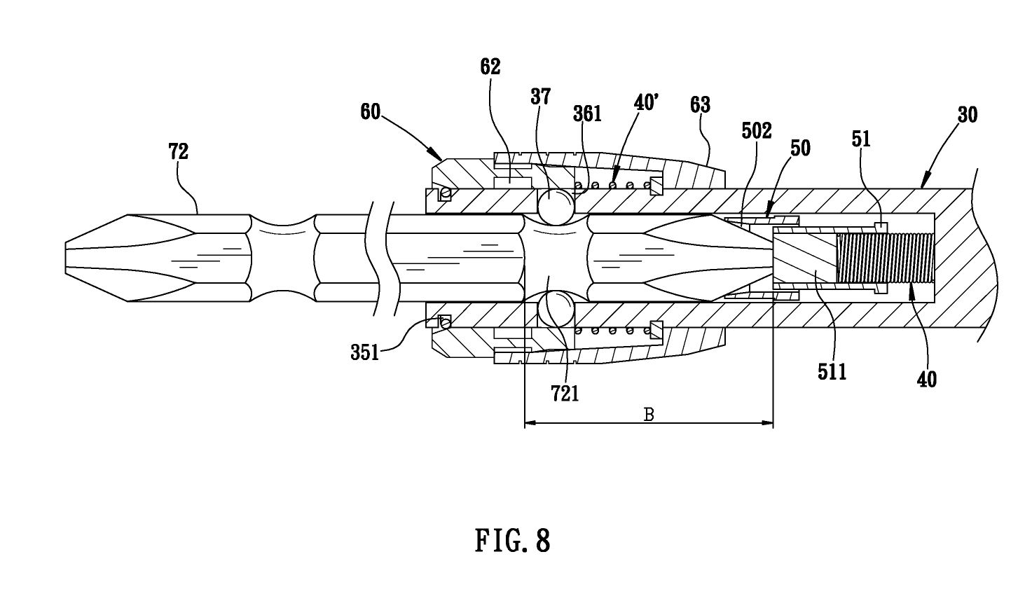

Referring to FIG. 8, a bidirectional screwdriver 72 has a positioning circular slot 721 on its lateral side which is spaced with a awl-shaped plugging unit 722 by distance B (maximum distance), so when the bidirectional screwdriver 72 is pushed into the plugging trough 32, the steel ball 37 is first retracted into the arc circular slot 33 of the ring 321 to form a space to enable the bidirectional screwdriver 72 to be pushed into. The awl-shaped plugging unit 722 pushes the linking unit 51 down along the inclined surface 502 in the movable inner tube 50, such that the steel ball 37 located between the retractable hole 361 and the hollow tube 60 is moved into the positioning circular slot 721 of the bidirectional screwdriver 72 which pushes the first resilient unit 40. Furthermore, the hollow tube 60 is pushed to the wedging ring 351 by the second resilient unit 40′ so the planar portion 3511 of the wedging ring 351 is against the lateral surface of the screwdriver 70 to achieve the effect of securing the screwdriver 72. Or, the plastic unit 63 pushes the hollow tube 60 and the second resilient unit 40′ to cause the steel ball 37 rolling into the ring-shaped slot 62, such that the positioning circular slot 721 of the bidirectional screwdriver 72 can be separated from the steel ball 37 due to the resilient force exerted from the first resilient unit 40 to the linking unit 51, and the property of quick separation significantly enhances the user experience. Thus, the present invention provides quick connection and separation with the screwdriver 70 of various sizes on the current market to increase practicability.

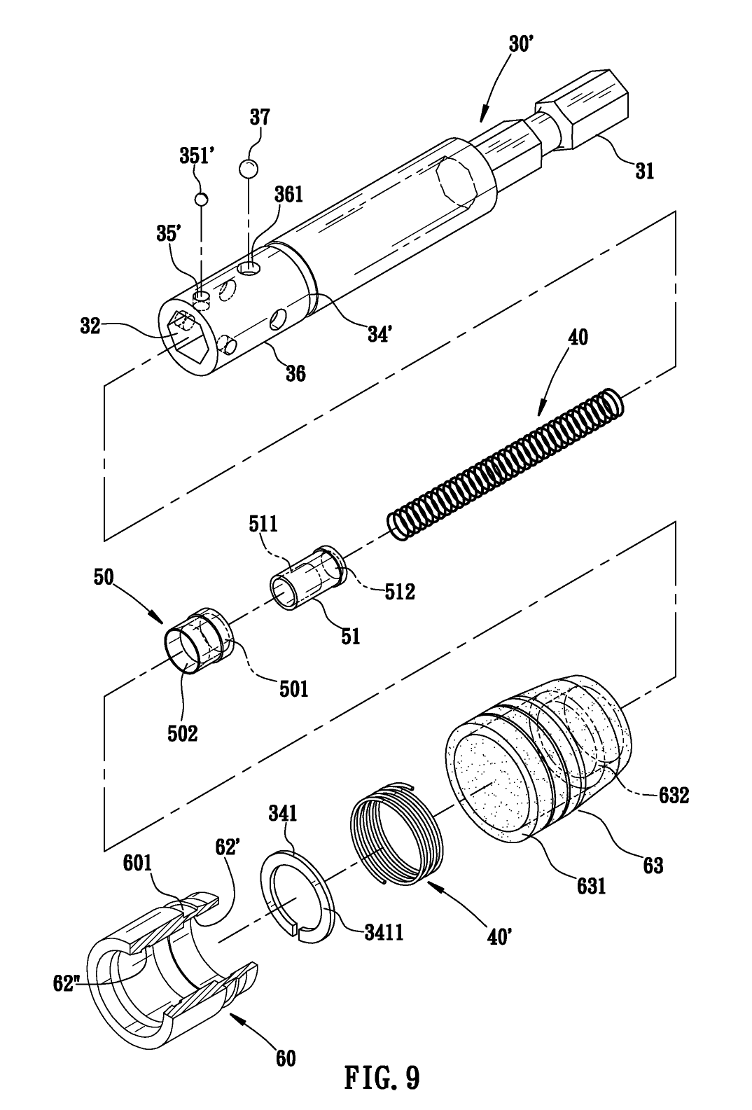

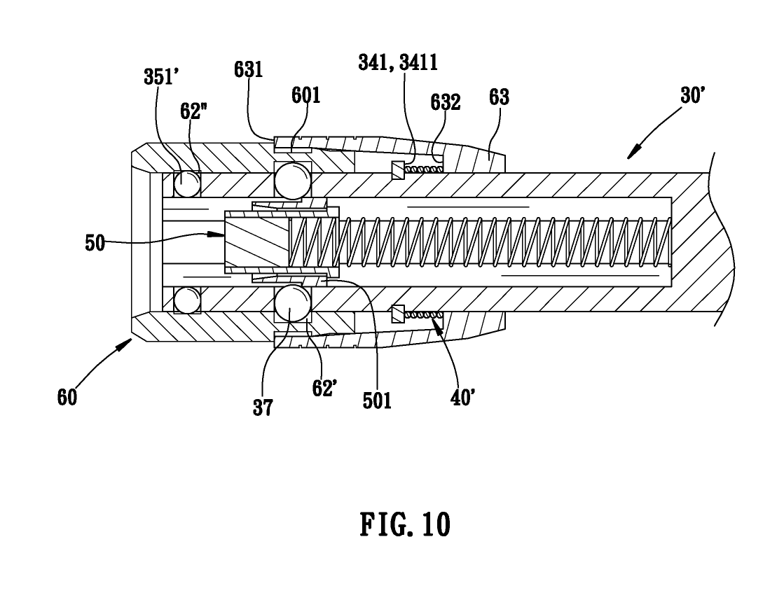

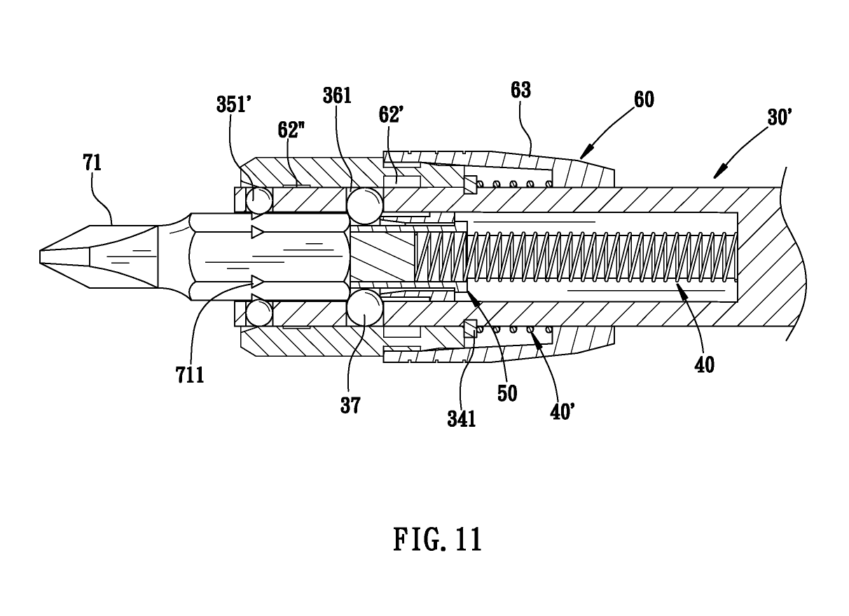

In one embodiment shown in FIGS. 9 and 10, outer surface of the elongated rod body 30′ has a circular slot 34′ and at lease one retractable opening 35′ to accommodate a protruding C-shaped wedging ring 341 to form a first shoulder portion 3411 to engage with a ball 351′. A connection portion 36 is formed between the circular slot 34′ and the retractable opening 35′, and an arc retractable hole 361 is formed at an appropriate location of the surface of the connection portion 36 to accommodate the steel ball 37. The second resilient unit 40′ and a big circular slot 62′ and a small circular slot 62″ of the hollow tube 60 are put together on one side of a C-shaped wedging ring 341 by a connecting portion 31 and the connection portion 36, such that the ball 351′ and the steel ball 37 can be positioned in the small circular slot 62″ and the big circular slot 62′, respectively. A groove 601 is formed at the outer surface of the hollow tube 60 and the groove 601 can attach to one surface 631 of a plastic heat-contractible unit 63, such that the hollow tube 60, the second resilient unit 40′ and the protruding ring 341 are all protected inside the heat-contractible unit 63, and one end of the second resilient unit 40′ is against the first shoulder portion 3411 and the other end of the second resilient unit 40′ is against the second shoulder portion 632 in the plastic unit 63 to compress the second resilient unit 40. When the screwdriver 71 (as shown in FIG. 11) is inserted into the plugging trough 32, the screwdriver 71 can push back the plastic unit 63 to force the ball 351′ to roll into the wedging gap 52 of the movable inner tube 50 to secure the screwdriver 71.

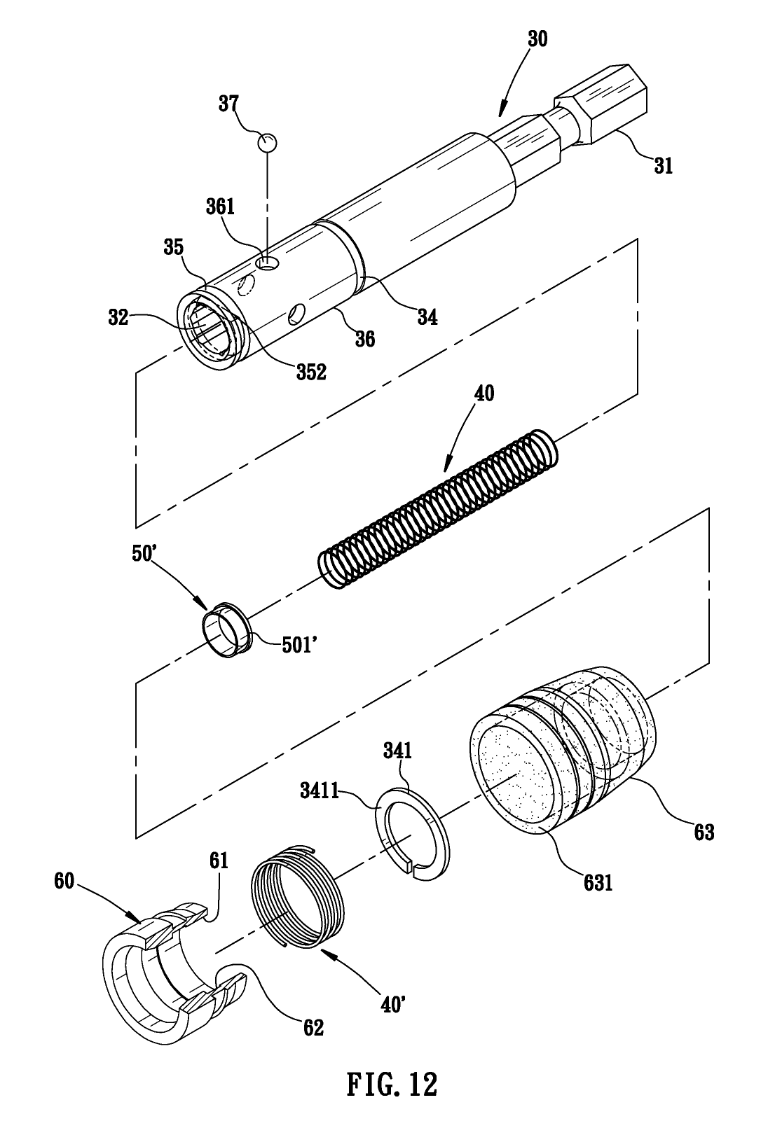

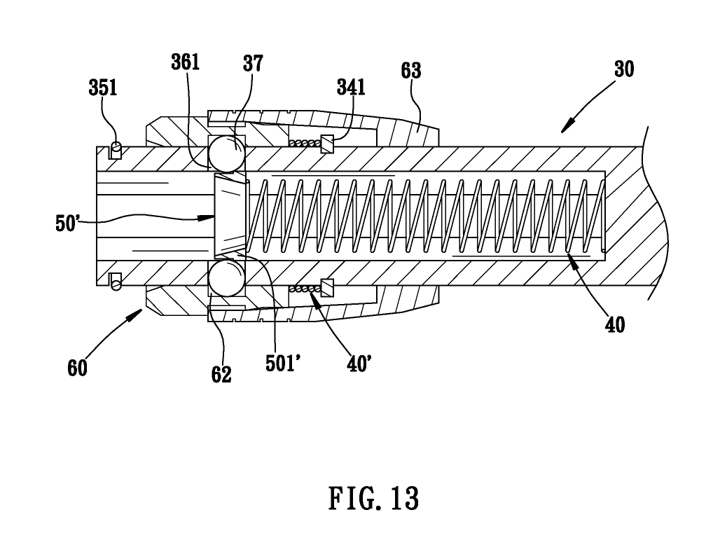

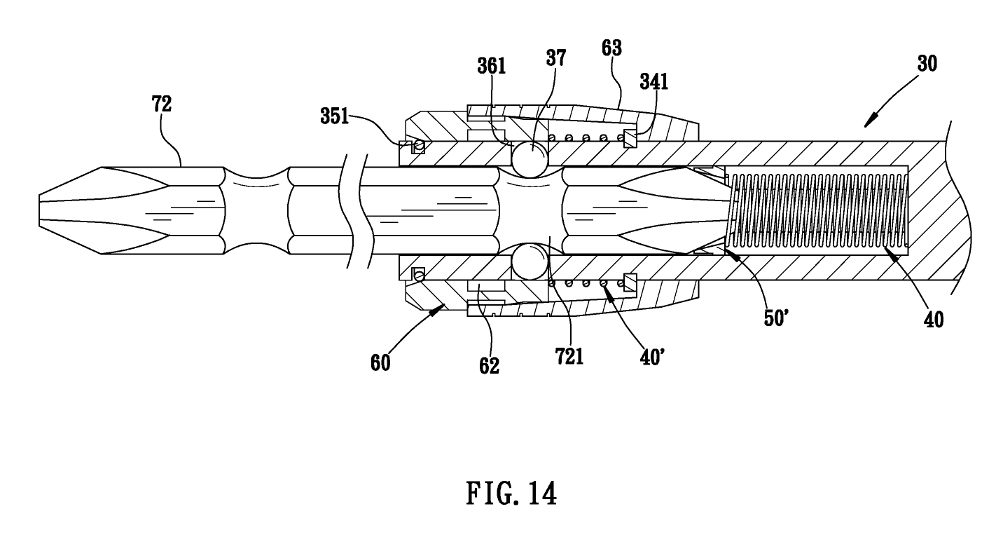

As can be seen in FIGS. 12 to 14, the inner diameter of the movable inner tube 50′ is slightly smaller than the outer diameter of the first resilient unit 40 to form a stopping portion 501′ to smoothly compress the first resilient unit 40, and the stopping portion 501′ is attached to the ring 321 of the plugging trough 32 such that the steel ball 37 is stopped by the stopping portion 501′ to further restrict the movable inner tube 50′ in the plugging trough 32 to avoid falling out.

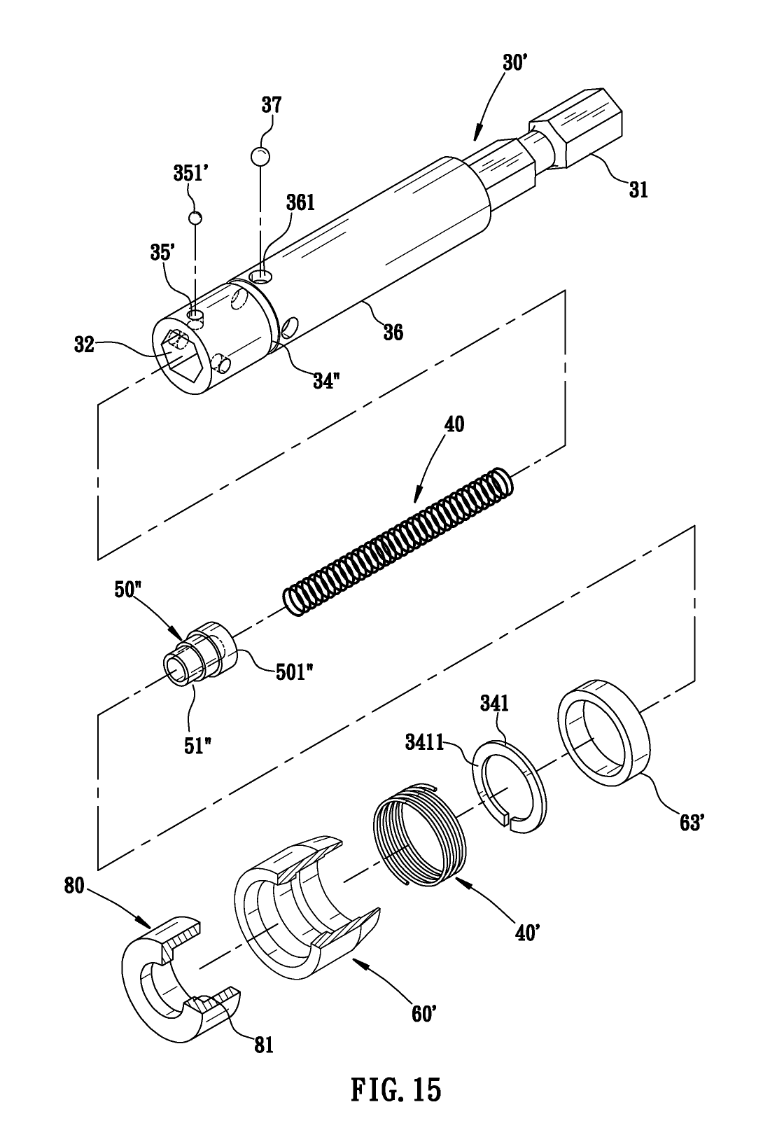

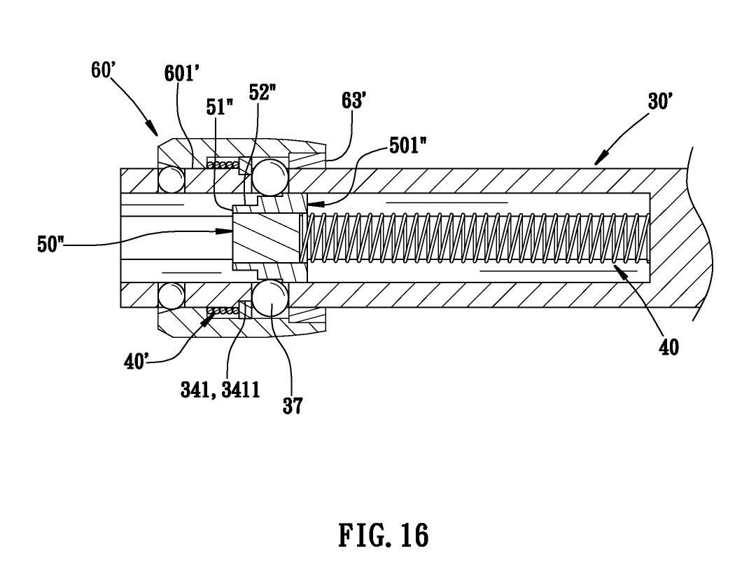

In another embodiment illustrated in FIGS. 15 and 16, a circular slot 34″ can be formed between the retractable hole 361 and the retractable opening 35′, closer to the retractable hole 361 to enable the C-shaped wedging ring 341 to form the first shoulder portion 3411. The connecting portion 31 is coupled with a hollow tube 60′ and a ring body 63′ which is located at one side of the retractable hole 361 to drive the outer portion of the elongated rod body 30′. The plugging trough 32 is coupled with the second resilient unit 40′ to limit the steel ball 37 between the C-shaped wedging ring 341 and the ring body 63′. Also, one end of the second resilient unit 40′ is against the first shoulder portion 3411 and the other end is against a second shoulder portion 601′ in the hollow tube 60′. The outer portion of the movable inner tube 50″ is ladder-shaped and formed a stopping portion 501″ to attach to the ring 321 at one end, the other end forms a connecting segment 51″ with smaller diameter and provides a wedging slot 52″ for the steel ball 37. When the hollow tube 60′ pushes the second resilient unit 40′ backward, the steel ball 37 rolls from the wedging slot 52″ of the movable inner tube 50″ to the inner wall of the hollow tube 60′ and the ball 351′ rolls into the positioning slot 711 of the screwdriver 71. Or, the steel ball 37 rolls from the wedging slot 52″ of the movable inner tube 50″ to the positioning slot 721 of the screwdriver 72 to secure every kind of screwdriver 70.

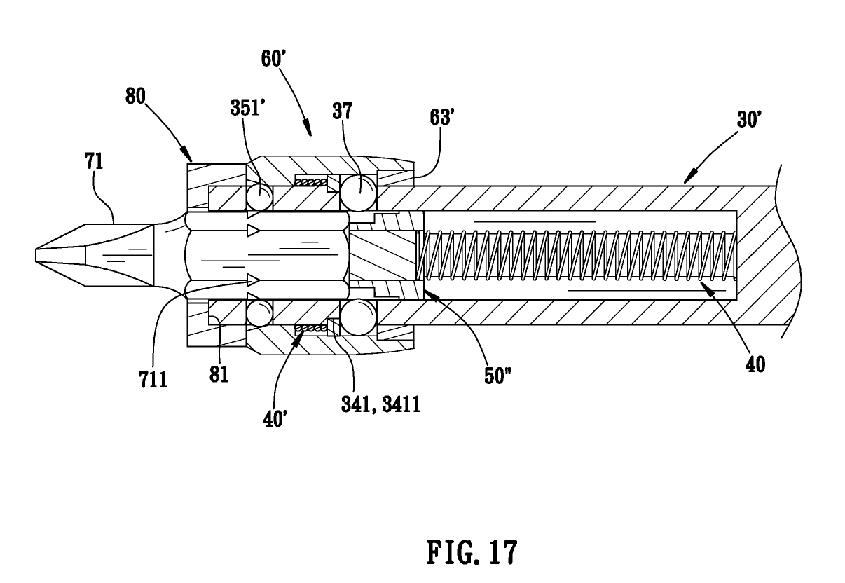

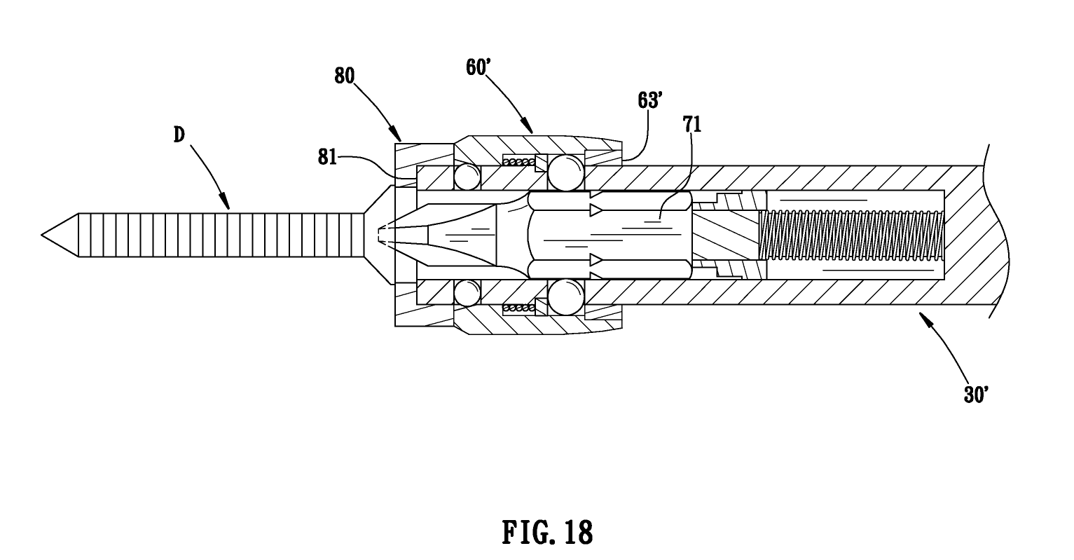

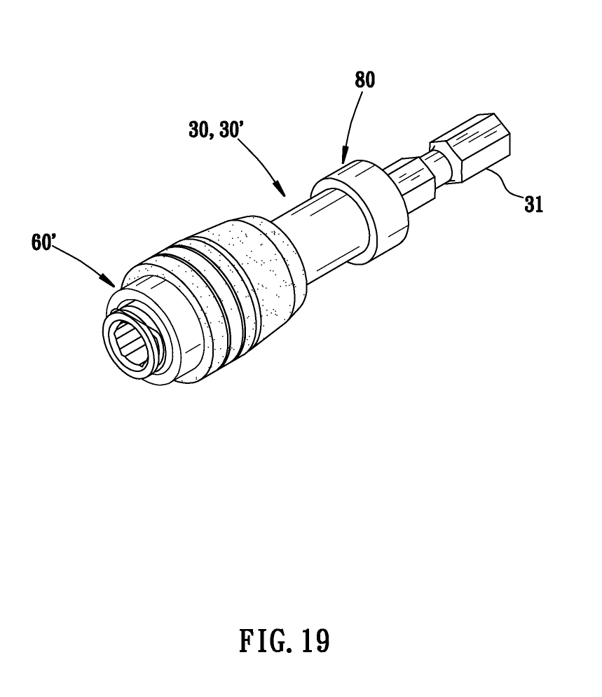

A positioning ring 80 is located at one end of the plugging trough 32 and one end of the positioning ring 80 has a protruding and magnetic ring wall 81 to attract and secure with one end of the elongated rod body 30, such that the hollow tube (60′ as shown in FIG. 17) is secured at a fixed position by the positioning ring 80, and the steel ball 37 is located between the retractable hole 361 and the inner wall of the hollow tube 60′ after the screwdriver 71 is inserted, and the screwdriver 71 is not restricted by the steel ball 37 and can retractably move in the plugging trough 32. When the user attach a screw with a flat surface on one end (D, as shown in FIG. 18) to the screwdriver 71, the screw D is secured and attracted to the ring wall 81 of the positioning ring 80. Thus, the user does not have to frequently change the screwdriver 70 with different sizes due to different sizes of screws. Also, when the positioning ring 80 is not in use, it can be received in to the elongated rod body (30, 30′) from the connecting portion 31 as depicted in FIG. 19.

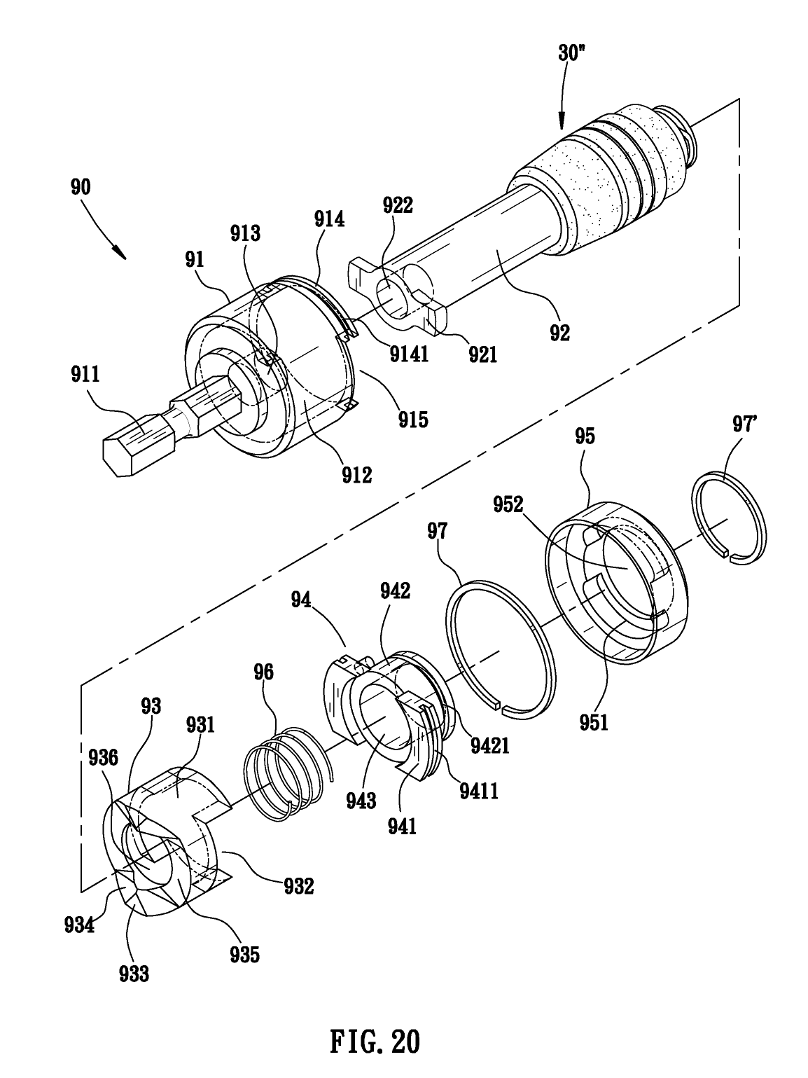

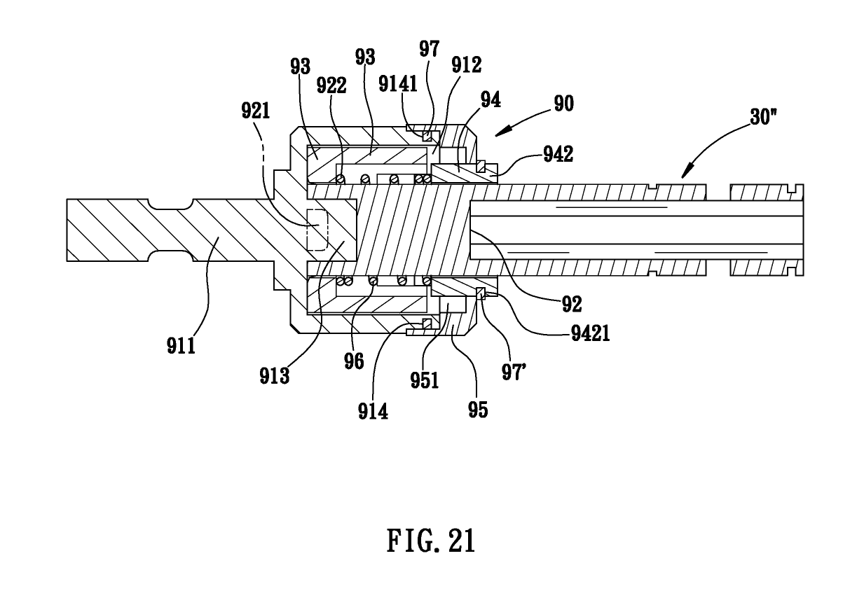

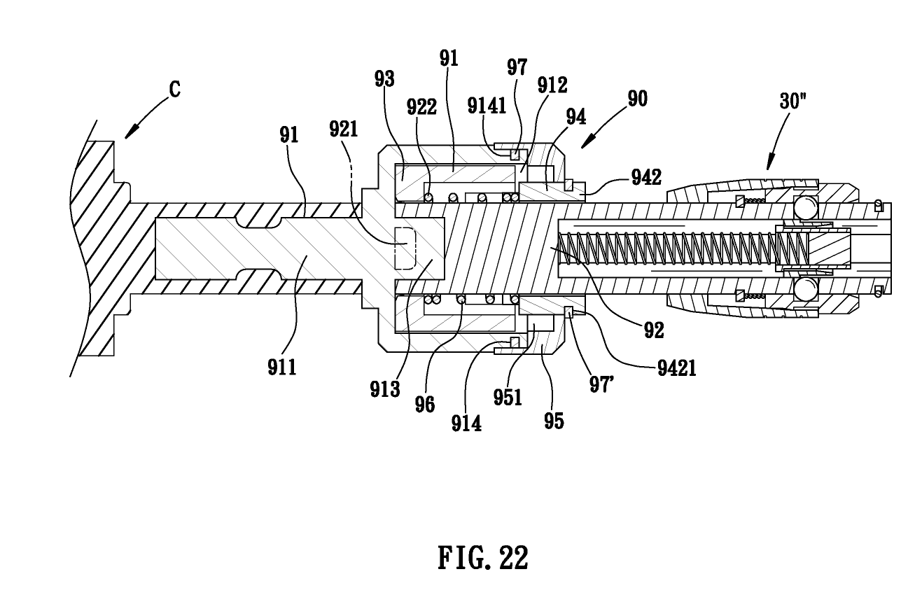

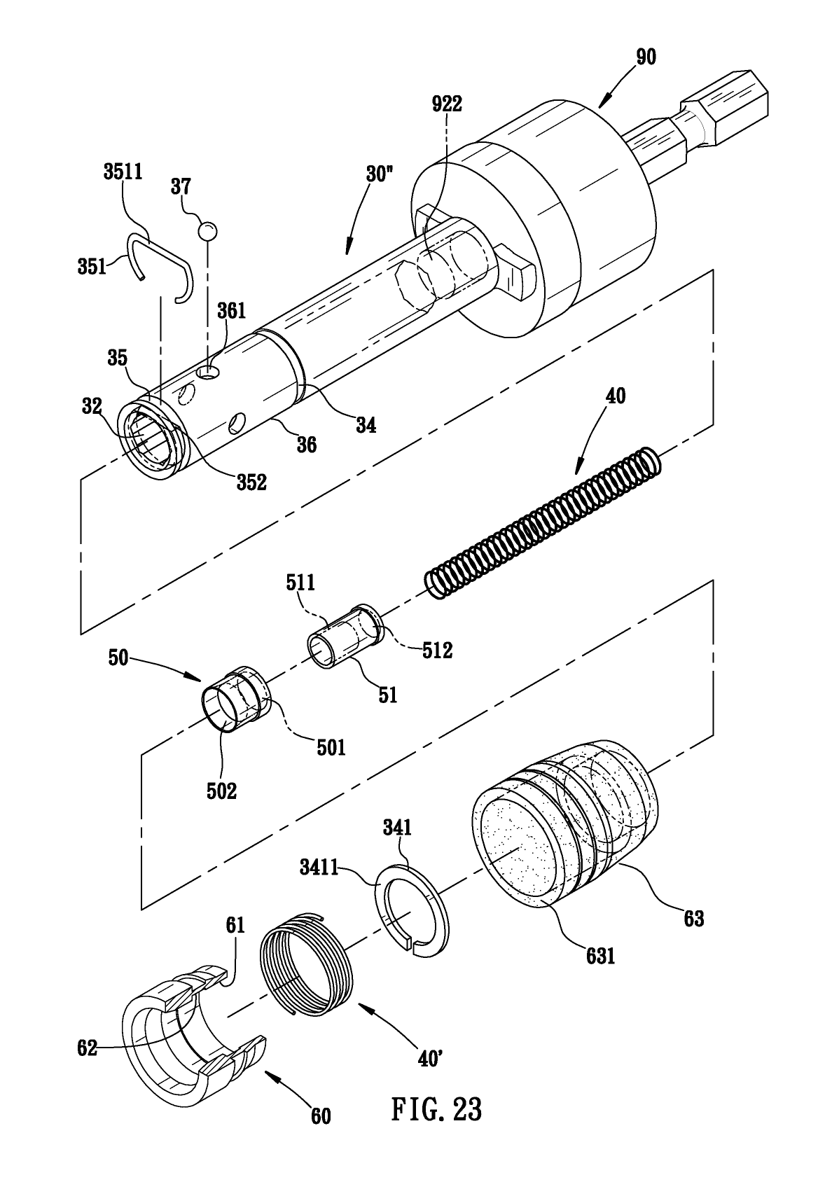

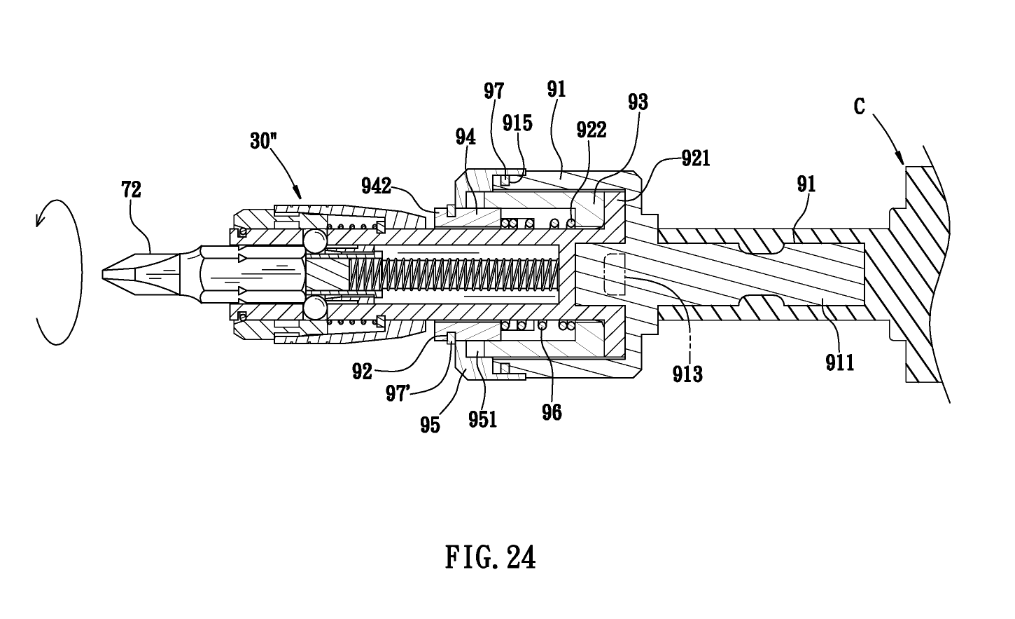

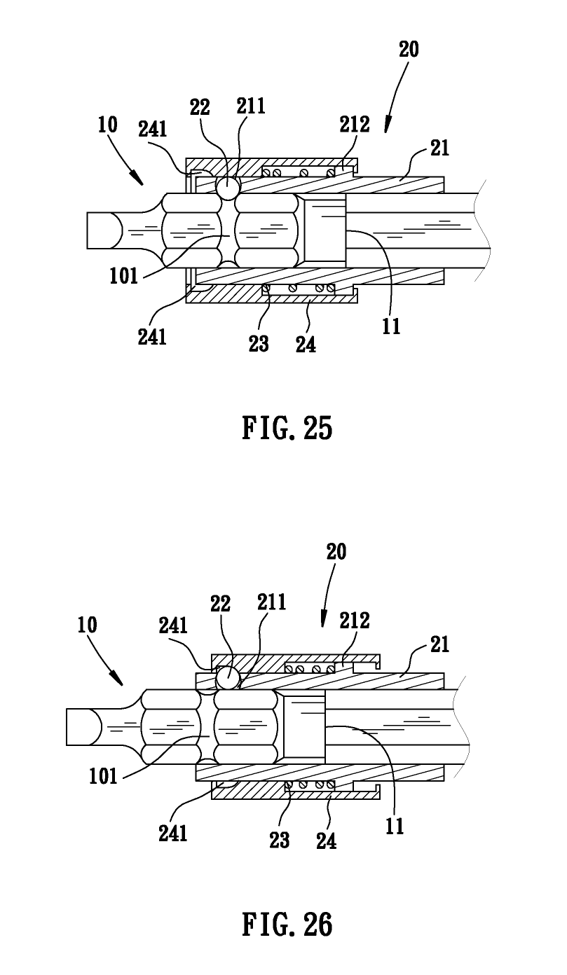

Referring to FIGS. 20 and 21, the elongated rod body 30″ can be coupled with a torque device 90 which includes a base 91, a shaft 92, a twisting unit 93, a positioning element 94 and a cap 95, wherein a hexagonal connecting rod 911 is extended from one side of a center of the base 91 to connect and position a driving tool C with a hexagonal opening (as shown in FIG. 22), while the other side of the center forms a protruding column 913 with a receiving slot 912 to form a pushing unit 921 with a pit hole 922 on one side of the shaft 92. A linking element 914 and a positioning opening 915 are formed outside the receiving slot 912, and a groove slot 9141 is formed at the edge of the linking element 914. The other end of the shaft 92 is a connecting rod (30″, as shown in FIG. 23). The twisting unit 93 has an arc pushing block 931 and a positioning opening 932 on one side, and a protruding unit 933 with a guiding edge 934 on the other side to form a pushing space 935 in the center portion. The shaft 92 is enclosed by a center opening 936 of the twisting unit 93 and against the pushing unit 921. One side of the positioning element 94 has a pair of positioning slots 9411 on wing blocks 941, and the other side has a ring segment 942 with ring slot 9421 and forms a center hole 943 to engage with the shaft 92, such that two wing blocks 941 of the positioning element 94 are positioned between two positioning openings 932 of the twisting unit 93 and against the edges of two pushing blocks 931. Also, the wing blocks 941 are located at the receiving slot 912 of the base 91 so the positioning slots 9411 of the wing blocks 941 are connected with the groove slot 9141 of the linking element 914. A C-shaped positioning ring 97 enables the twisting unit 93 to be positioned between the base 91 and the positioning element 94, and a spring 96 is between the twisting unit 93 and the positioning element 94 to force two pushing blocks 931 of the twisting unit 93 to protrude out from receiving slot 912. An evading slot 951 is formed on both sides of the cap 95 to evade the pushing block 931 of the twisting unit 93. Moreover, a cap opening 952 is formed at the center of the cap 95 to engage with the shaft 92 and the base 91, and the ring segment 942 of positioning element 94 is protruding form the cap opening 952 of the cap 95 to couple with a smaller C-shaped ring 97′ to secure a position on the ring slot 9421. When the torque device 90 is coupled with the driving tool C to connect the elongated rod body 30″ with various type of screwdrivers 70 to perform screwing process (as shown in FIG. 24), the pushing unit 921 of the shaft 92 can be driven by the spring 96 to move within the pushing space 935 of the twisting unit 93. Furthermore, when the screwdriver 70, spinning at a high speed driven by the driving tool C, continues to perform the screwing process while encountering obstacles, the shaft 92 generates setback force to enable the spring 96 to push the pushing unit 921, so the pushing unit 921 can slide along the guiding edge 934 to the protruding unit 933 in the pushing space 935 by resilient force generated by spring 96. Under such circumstances, an idle status can be formed to prevent the screwdriver 70 from deforming or breaking due to continuously receiving instant torque exerted by the driving tool.

Having described the invention by the description and illustrations above, it should be understood that these are exemplary of the invention and are not to be considered as limiting. Accordingly, the invention is not to be considered as limited by the foregoing description, but includes any equivalents.

What is claimed is:

1. An apparatus for fast connecting a screwdriver blade comprises a an elongated rod body, a first resilient unit, a second resilient unit, a movable inner tube and a hollow tube, wherein an inner portion of the elongated rod body has a plugging trough to accommodate the first resilient unit and the movable inner tube therein;
and a circular ring is located at outer diameter of the plugging trough to connect edge of the plugging trough to form an ring slot; and a wedging groove with an opening is formed outside the elongated rod body to engage a planar portion of a wedging ring, wherein a connecting element with a retracting hole is configure to receive a steel ball, and the second resilient unit and the hollow tube are coupled at the outer portion of the connecting element, wherein a circular slot at inner wall of the hollow tube is aligned with the retracting hole and the a wedging trough is formed where the movable inner tube is aligned with inner wall of the elongated rod body, so different sizes of the screwdriver blades can be inserted into or pulled out from the elongated rod body to push the first and second resilient units to cause the steel ball rolling into the wedging trough along the ring slot or into an positioning ring slot of the screwdriver blade.

2. The apparatus of claim 1, wherein shape of the plugging trough of the elongated rod body is hexagonal.

3. The apparatus of claim 1, wherein the circular slot is formed outside the elongated rod body which is spaced with the wedging groove in a predetermined distance to form a larger diameter C-shaped protruding ring to form a first shoulder portion, wherein one side of the wedging groove has a planar through hole to communicate with the plugging trough, such that the wedging ring is aligned with a surface of the opening of the wedging groove, and protruding to one side of the plugging trough.

4. The apparatus of claim 1 or claim 3, wherein one end of the hollow tube is formed a second shoulder portion aligned with the protruding ring of the first shoulder portion, such that the second resilient unit is restricted by the first and the second shoulder portions.

5. The apparatus of claim 1, wherein shape of the retracting hole of the elongated rod body is arc.

6. The apparatus of claim 1, wherein the movable inner tube is hollow and one end thereof has an inclined surface, and the other end forms a stopping end; said movable inner tube has a linking unit therein which is protruding at one side of the movable inner tube with ladder-shaped drop to form the wedging trough in an inner wall of the elongated rod body; and a magnetic unit is attached to each end of the linking unit and a receiving space is provided to accommodate the screwdriver and one end of the resilient unit.

7. The apparatus of claim 1, wherein inner diameter of the movable inner tube is smaller than outer diameter of the first resilient unit, such that a stopping surface if formed outside to smoothly compress the first resilient unit.

8. The apparatus of claim 1, wherein a depressed slot is formed at an outer surface of the hollow tube to provide a plastic engaging unit and one end of the engaging unit attaches to the depressed slot, such that the hollow tube, the to move altogether.

9. An apparatus for fast connecting a screwdriver blade includes a an elongated rod body, a first resilient unit, a second resilient unit, a movable inner tube and a hollow tube, wherein an inner portion of the elongated rod body has a plugging trough to accommodate the first resilient unit and the movable inner tube therein; and a circular ring is located at outer diameter of the plugging trough to connect edge of the plugging trough to form an ring slot, wherein a retractable hole is formed outside the elongated rod body for a wedging ball and a connecting portion with a retractable hole is formed for a steel ball and a ring slot is provide to engage with a protruding ring of a first shoulder portion, wherein a wedging trough is formed in the movable inner tube, such that when screwdrivers with different sizes are inserted into or pulled out from the rod body, the elongated rod body pushes the first and the second resilient units to roll the steel ball into the wedging trough along the ring slot or into a positioning ring slot of the screwdriver.

10. The apparatus of claim 9, wherein shape of the plugging trough of the elongated rod body is hexagonal.

11. The apparatus of claim 9, wherein shape of the retractable opening and retractable hole is arc.

12. The apparatus of claim 9, wherein the ring slot is formed on an opposite side of the retractable opening and retractable hole.

13. The apparatus of claim 9, wherein the ring slot is located between the retractable opening and the retractable hole, and is close to the retractable opening.

14. The apparatus of claim 9, wherein a big and a small ring slots are formed at inner wall of the hollow tube to provide space for at least a portion of the wedging ball and the steel ball.

15. The apparatus of claim 9, wherein the movable inner tube is hollow and one end thereof is against the circular ring with a circumference, and the other end has an inclined surface inside, wherein a linking unit is formed which is protruding to one end of the movable inner tube with ladder-shaped drop to form the wedging trough in the inner wall of the elongated rod body, and the linking unit has a magnetic unit and a receiving space to secure the screwdriver and one end of the first resilient unit.

16. The apparatus of claim 9, wherein the movable inner tube is hollow and ladder-shaped outside; one end thereof is against the circular ring with a circumference and the other end has a linking segment having smaller diameter with an inclined surface to form a wedging trough at the inner wall of the elongated rod body, and the linking segment has a magnetic unit and inner portion of the circumference has a receiving space to secure the screwdriver and one end of the first resilient unit.

17. The apparatus of claim 9, wherein inner diameter of the movable inner tube is smaller than outer diameter of the first resilient unit, such that a stopping surface is formed to smoothly compress the first resilient unit.

18. The apparatus of claim 9, wherein one end of inner portion of a plastic tube is formed a second shoulder portion with smaller diameter aligned with the protruding ring of the first shoulder portion, such that the second resilient unit is restricted by the first and the second shoulder portions.

19. The apparatus of claim 9, wherein one end of the hollow tube is formed a second shoulder portion aligned with the protruding ring of the first shoulder portion, such that the second resilient unit is restricted by the first and the second shoulder portions.

20. The apparatus of claim 9, wherein one end of the hollow tube has a ring body attaching to the protruding ring, so the ring body is driven by pushing the hollow tube.

21. The apparatus of claim 9, wherein the elongated rod body has a connecting portion; and a positioning ring is located at one end of the plugging trough and one end of the positioning ring has a protruding and magnetic ring wall to attract and secure with one end of the elongated rod body, such that the hollow tube is secured at a fixed position by the positioning ring, and the steel ball is located between the retractable hole and the inner wall of the hollow tube after the screwdriver is inserted, such that the screwdriver moves retractably in the plugging trough without being restricted by the steel ball, and when the positioning ring is not in use, it is stored in the connecting portion of the elongated rod body.

22. An apparatus for fast connecting a screwdriver blade comprises a an elongated rod body, a first resilient unit, a second resilient unit, a movable inner tube and a hollow tube, wherein an inner portion of the elongated rod body has a plugging trough to accommodate the first resilient unit and the movable inner tube therein; and a circular ring is located at outer diameter of the plugging trough to connect edge of the plugging trough to form an ring slot; and a wedging groove with an opening is formed outside the elongated rod body to engage a planar portion of a wedging ring, wherein a connecting element with a retracting hole is configure to receive a steel ball, and the second resilient unit and the hollow tube are coupled at the outer portion of the connecting element, wherein a circular slot at inner wall of the hollow tube is aligned with the retracting hole and the a wedging trough is formed where the movable inner tube is aligned with inner wall of the elongated rod body, so different sizes of the screwdriver blades can be inserted into or pulled out from the elongated rod body to push the first and second resilient units to cause the steel ball rolling into the wedging trough along the ring slot or into an positioning ring slot of the screwdriver blade; and the elongated rod body is coupled with a torque device which includes a base, a shaft, a twisting unit, a positioning element and a cap, wherein a hexagonal connecting rod is extended from one side of a center of the base to connect and position a driving tool with a hexagonal opening, while the other side of the center forms a protruding column with a receiving slot to form a pushing unit with a pit hole on one side of the shaft, wherein a linking element and a positioning opening are formed outside the receiving slot, and a groove slot is formed at the edge of the linking element, wherein the twisting unit has an arc pushing block and a positioning opening on one side, and a protruding unit with a guiding edge on the other side to form a pushing space in the center portion, and one side of the positioning element has a pair of positioning slots on wing blocks, and the other side has a ring segment with ring slot and forms a center hole to engage with the shaft, such that two wing blocks of the positioning element are positioned between two positioning openings of the twisting unit and against the edges of two pushing blocks, and the wing blocks are located at the receiving slot of the base so the positioning slots of the wing blocks are connected with the groove slot of the linking element, wherein a C-shaped positioning ring enables the twisting unit to be positioned between the base and the positioning element, and a spring is between the twisting unit and the positioning element to force two pushing blocks of the twisting unit to protrude out from receiving slot, and a cap opening is formed at the center of the cap to engage with the shaft and the base, and the ring segment of positioning element is protruding form the cap opening of the cap to couple with a smaller C-shaped ring to secure a position on the ring slot.

23. The apparatus of claim 22, wherein shape of the plugging trough is hexagonal.

24. The apparatus of claim 22, wherein the circular slot is formed outside the elongated rod body which is spaced with the wedging groove in a predetermined distance to form a larger diameter C-shaped protruding ring to form a first shoulder portion, wherein one side of the wedging groove has a planar through hole to communicate with the plugging trough, and a planar portion of the wedging ring is aligned with a surface of the opening of the wedging groove

25. The apparatus of claim 22, wherein one end of the hollow tube is formed a second shoulder portion aligned with the protruding ring of the first shoulder portion, such that the second resilient unit is restricted by the first and the second shoulder portions.

26. The apparatus of claim 22, wherein shape of the retractable hole of the elongated rod body is arc.

27. The apparatus of claim 22, wherein the movable inner tube is hollow and one end thereof is against the circular ring with a circumference, and the other end has an inclined surface inside, wherein a linking unit is formed which is protruding to one end of the movable inner tube with ladder-shaped drop to form the wedging trough in the inner wall of the elongated rod body, and the linking unit has a magnetic unit and a receiving space to secure the screwdriver and one end of the first resilient unit.

28. The apparatus of claim 22, wherein inner diameter of the movable inner tube is smaller than outer diameter of the first resilient unit, such that a stopping surface is formed to smoothly compress the first resilient unit.

29. The apparatus of claim 22, a depressed slot is formed at an outer surface of the hollow tube to provide a plastic engaging unit and one end of the engaging unit attaches to the depressed slot, such that the hollow tube, the second resilient unit and the protruding ring are enclosed by the engaging unit to move altogether.
